(19) United States
(12) Patent Application Publication
(10) Pub. No.: US 2025/0292222 A1
(43) Pub. Date: Sep. 18, 2025

(54) CONTENT SECURITIZATION SYSTEM

(71) Applicant: Wonjin CHOI, Daejeon (KR)

(72) Inventors: Wonjin CHOI, Daejeon (KR); Miran BAEK, Gyeongsangnam-do (KR)

(21) Appl. No.: 19/221,549

(22) Filed: May 29, 2025

Related U.S. Application Data
(63) Continuation of application No. PCT/KR2023/017620, filed on Nov. 6, 2023.

(30) Foreign Application Priority Data
Dec. 2, 2022 (KR) 10-2022-0166316
Dec. 5, 2022 (KR) 10-2022-0167866
Jan. 5, 2023 (KR) 10-2023-0001839

(51) Int. Cl. G06Q 20/10; G06Q 20/12

(52) U.S. Cl. CPC G06Q 20/102; G06Q 20/123

(57) ABSTRACT

Disclosed are a content securitization system and an operation method thereof. The present invention relates to a content securitization system and an operation method thereof, the content securitization system comprising: a content securities issuance unit configured to issue content securities on which distribution rights to profits to be generated from content of a content creator are written; a content securities sales unit configured to sell the content securities issued by the content securities issuance unit; a profit distribution unit configured to settle profits generated from the content as content profits; and a profit distribution unit configured to distribute the settled content profits to the content creator or a content securities investor.

### CROSS-REFERENCE TO RELATED APPLICATION

This application is a US Bypass Continuation Application of International Application No. PCT/KR2023/017620, filed on Nov. 6, 2023, which claims priority to and the benefit of Korean Patent Application No. 10-2022-0166316, filed on Dec. 2, 2022, Korean Patent Application No. 10-2022-0167866, filed on Dec. 5, 2022, and Korean Patent Application No. 10-2023-0001839, filed on Jan. 5, 2023, the disclosure of which is incorporated herein by reference in its entirety.

### BACKGROUND

### Technical Field

Various embodiments of the present invention relate to a content securitization system.

### Background Art

Digital contents refer to digitized information that is traded or exchanged through various wired and wireless communication networks, and is content that has been digitally created or processed to be distributed via wired and wireless communication networks. For example, it refers to all intangible information distributed online, such as text information like e-books, multimedia data (e.g., images, music, videos, games, etc.), which can be easily replicated and distributed using storage media (e.g., CDs, floppy disks, etc.) or information streams through the Internet.

Recently, with the development of information and communication technologies such as computers and the Internet, anyone with the ability to develop content can create various types of digital content. Although such digital content may require significant effort and cost to develop, once development is complete and it is distributed online, additional replication costs are minimal, making it possible to obtain high profits in the case of popular digital content.

Meanwhile, a video-sharing platform has been developed, where a content creator posts video content online and inserts advertisements into the video content, and when users watch or click the advertisements along with the video content, a portion of the advertisement revenue is paid to the content creator based on the ad viewing time and number of views.

However, from the perspective of the content provider, there is a limitation in that aside from such revenue, there are no additional ways to generate profit or secure funding, and they must rely on the existing revenue (structure).

Furthermore, in order for a content provider to create more innovative content, additional production costs are required, and until now, those costs had to be covered personally, making it difficult to receive external investment. Therefore, new content faced limitations in significant development or creativity due to production cost constraints, often remaining within a certain category.

### SUMMARY

### Technical Problem

According to various embodiments of the present invention, a content securitization system can be provided that enables content creators (or content producers) to secure production costs through content securities and to promote content creation by sharing revenue generated from the content with content security investors.

The problems to be solved by the present invention are not limited to those mentioned above, and other problems not mentioned will be clearly understood by those skilled in the art from the following description.

### Technical Solution

According to various embodiments of the present invention, the content securitization system includes: a content security issuance unit configured to issue content securities that state the right to share in the revenue that may be generated from the content creator's content; a content security sales unit configured to sell the content securities issued by the content security issuance unit; a revenue distribution unit configured to settle the revenue generated from the content as content revenue; and a revenue distribution unit configured to distribute the settled content revenue to the content creator or content security investors; wherein the revenue distribution unit may be configured such that the amount corresponding to the proportion allocated to the content creator from the settled content revenue is distributed to the content creator, and the remaining amount excluding the amount distributed to the content creator from the settled content revenue is distributed to each content security holder in accordance with their holding ratio of the content securities.

According to various embodiments, the content securities may be provided as non-fungible tokens (NFTs).

According to various embodiments, the revenue generated from the content may be revenue generated from specific content designated by the content creator.

According to various embodiments, the revenue generated from the content may be revenue generated from all types of specific content designated by the content creator. (For example, in the case where content creator A produces music content and video content, depending on content creator A's selection, only all of content creator A's video content may be subject to revenue, or only all of content creator A's music content may be subject to revenue, or, of course, all of content creator A's video and music content may be subject to revenue.)

According to various embodiments, the revenue generated from the content may be revenue generated from all content created by the content creator.

According to various embodiments, the revenue distribution unit may be configured to distribute the settled content revenue to the content creator, the content security investors, or the content promoters.

According to various embodiments, the revenue distribution unit may be configured such that the amount corresponding to the proportion allocated to the content creator from the settled content revenue is distributed to the content creator, the amount corresponding to the proportion allocated to the content security investors from the settled content revenue is distributed to each content security holder in accordance with their holding ratio of the content securities, and the amount corresponding to the proportion allocated to the content promoters from the settled content revenue is distributed to each content promoter in accordance with a contribution score.

According to various embodiments, the revenue distribution unit may be configured to distribute, based on the revenue generated from subsequent content of the content, an amount corresponding to the proportion allocated to the content security investors from the subsequent content revenue settled by the revenue settlement unit, to each content security holder in accordance with their holding ratio of the content securities.

According to various embodiments, the content securities may be provided as non-fungible tokens (NFTs).

According to various embodiments of the present invention, the method of operating the content securitization system may include: receiving a request to issue content securities; issuing the content securities; selling the content securities; settling the revenue generated from the content; and distributing the settled content revenue to the content creator and the content security investors based on the content securities.

### Effects of the Invention

The content securitization system according to various embodiments of the present invention can allow a content creator (or content producer) to secure production costs through content securities, and to promote content creation by sharing the revenue generated from the content with content security investors.

The effects of the present invention are not limited to those mentioned above, and other effects not mentioned will be clearly understood by those skilled in the art from the following description.

### BRIEF DESCRIPTION OF THE DRAWINGS

FIG. 1 is a diagram for explaining a content securitization system according to various embodiments of the present invention.

FIG. 2 is a block diagram of the content securitization system according to various embodiments of the present invention.

FIG. 3 is a flowchart for explaining the method of operating the content securitization system according to various embodiments of the present invention.

FIG. 4 is a schematic diagram for explaining the criteria for individual content revenue distribution according to various embodiments of the present invention.

FIG. 5 is a schematic diagram for explaining the criteria for total content revenue distribution according to various embodiments of the present invention.

FIG. 6 is a schematic diagram for explaining the criteria for content revenue distribution according to various embodiments of the present invention.

FIG. 7 is a schematic diagram for explaining the criteria for series content revenue distribution according to various embodiments of the present invention.

### DETAILED DESCRIPTION

Specific structural or functional descriptions of the embodiments according to the concept of the present invention disclosed in this specification are merely illustrated for the purpose of describing the embodiments according to the concept of the present invention, and the embodiments according to the concept of the present invention can be implemented in various forms and are not limited to the embodiments described in this specification.

Since the embodiments according to the concept of the present invention may undergo various changes and have various forms, the embodiments will be illustrated in the drawings and described in detail in this specification. However, this is not intended to limit the embodiments according to the concept of the present invention to the specific forms disclosed, and includes changes, equivalents, or substitutes within the spirit and scope of the present invention.

Terms such as first or second may be used to describe various components, but such components should not be limited by these terms. These terms are only used to distinguish one component from another component; for example, within the scope of the present invention, a first component may be referred to as a second component, and similarly, a second component may be referred to as a first component.

When a component is referred to as being “connected” or “coupled” to another component, it may be directly connected or coupled to the other component or may be indirectly connected or coupled through another component. On the other hand, when a component is referred to as being “directly connected” or “directly coupled” to another component, it should be understood that there are no other components in between. Expressions that describe the relationship between components, such as “between” and “directly between,” or “adjacent to” should be interpreted in the same manner.

The terminology used in this specification is only for the purpose of describing particular embodiments and is not intended to limit the invention. The singular form includes the plural unless the context clearly dictates otherwise. In this specification, terms such as “include” or “have” are intended to indicate the presence of stated features, numbers, steps, operations, components, parts, or combinations thereof, and should not be interpreted as excluding the possibility of the presence or addition of one or more other features, numbers, steps, operations, components, parts, or combinations thereof.

Unless otherwise defined, all terms including technical and scientific terms used herein have the same meaning as commonly understood by one of ordinary skill in the art to which this invention belongs. Terms generally defined in commonly used dictionaries should be interpreted to have meanings consistent with their meaning in the relevant art and should not be interpreted in an idealized or overly formal sense unless explicitly defined in this specification.

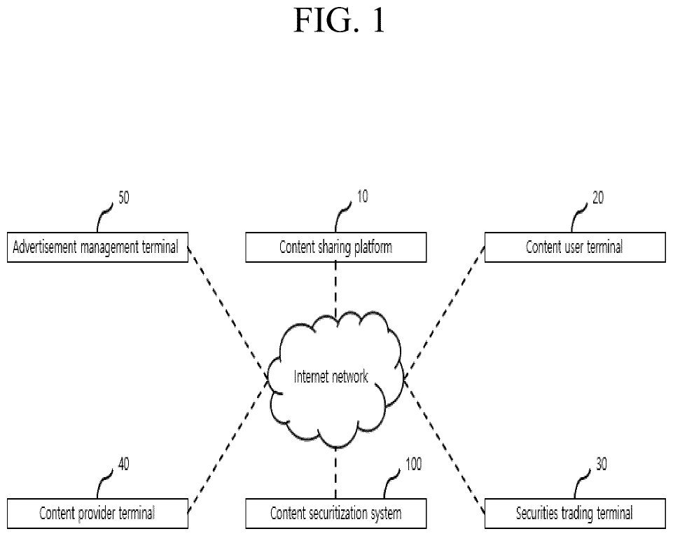

FIG. 1 is a diagram for explaining a content securitization system according to various embodiments of the present invention.

Referring to FIG. 1, the content securitization system (100) may be communicatively connected, via an Internet network such as a communication network, to a content sharing platform (10), a content user terminal (20), a securities trading terminal (30), a content provider terminal (40), or an advertisement management terminal (50).

The content securitization system (100) of the present invention can register content (or digital content) and provide it to content users, thereby distributing the revenue (or income) generated from the use of the content by content users to content providers (or content creators) and securities investors. Depending on the embodiment, securities for content revenue may be issued per individual content unit or per content provider (or content creator). Securities issued per individual content unit can distribute the revenue generated from the target content, which is the subject of issuance, to the investors who invested in the relevant security and the content creator. On the other hand, securities issued per content creator unit can distribute the revenue generated from all content previously created and to be created in the future by the content creator through the content sharing platform (10) to the investors who invested in the relevant security and the content creator.

According to various embodiments, securities for content revenue may be issued for a specific type of content of a content provider. Securities issued for a specific type of content of a content provider may distribute all revenue generated from the specific type of content of the relevant content creator (e.g., video content among various types of content by content creator A) to the investors who invested in the relevant security and the content creator.

The content securitization system (100) of the present invention targets arbitrary content shared on the content sharing platform (10), and it should be understood by those skilled in the art that it is not limited to digital content.

As an example of content, content may be freely available content posted online and may include photos, videos, games, or electronic documents. For example, the content sharing platform (10) may be at least one of various content sharing platforms such as a video sharing platform that provides videos (e.g., YouTube, etc.), an SNS sharing platform that provides photos or videos (e.g., Instagram, etc.), or an e-book sharing platform that provides electronic documents (e.g., Kmong, etc.), but is not limited thereto. In addition, the content sharing platform (10) of the present invention may be a sharing platform that integrates the video sharing platform, SNS sharing platform, and e-book sharing platform, but is not limited thereto.

Hereinafter, for the sake of convenience in explanation, the content sharing platform (10) and the content securitization system (100) are described by taking as an example a video sharing platform that provides video content and a securitization system that distributes revenue generated through video content via securities. However, it should be understood by those skilled in the art that the present invention is not limited thereto and may be applied to platforms that share arbitrary content. As described above, securities may be issued per individual content creator subscribed to the video sharing platform. In such a case, securities issued targeting the content creator may be utilized as elements for distributing to investors the revenue generated from video content already created and video content to be created in the future by the content creator.

Hereinafter, in the specification of the present invention, content (or digital content) may refer to a work produced by at least one of living organisms, non-living entities, or both. For example, content may include arbitrary works such as videos, photos, writings, books, drawings, etc., and the content may be created by living organisms, created by non-living entities (e.g., artificial intelligence), or created through the cooperation of living organisms and non-living entities.

According to one embodiment, the content securitization system (100) may be implemented in the form of a platform that provides images, videos, or information to users who access online through a securities trading terminal (30) via the Internet network. In this aspect, the content securitization system (100) of the present invention may be implemented in the form of a service server, but is not limited thereto.

Referring to FIG. 1, the content securitization system (100) may be connected to the content sharing platform (10) via the Internet network. According to some embodiments, the content sharing platform (10) may be defined and interpreted as a component of the content securitization system (100), but is not limited thereto. According to one embodiment, the content securitization system (100) may be provided as a service server, but is not limited thereto.

In addition, the content securitization system (100) may be operated and managed by a server operator, but is not limited thereto. Also, the content sharing platform (10) may be operated directly by the server operator or by another operator.

The content provider terminal (40) is a terminal (or client) used by a content creator (e.g., a content creator (producer)), and the securities trading terminal (30) may be a terminal (or client) used by an investor who invests in content securities related to specific content, or all content of a specific type created by a specific content creator, or all content created by a specific content creator. The content user terminal (20) is a terminal (or client) used by a content user who uses content (e.g., video) posted on the content sharing platform (10), and the advertisement management terminal (50) may be a terminal (or client) used by an advertiser who inserts advertisements into video content via the content sharing platform (10).

The content securitization system (100), the content sharing platform (10), the content user terminal (20), the securities trading terminal (30), the content provider terminal (40), or the advertisement management terminal (50) may be computing devices or smart devices composed of a CPU, RAM, ROM, magnetic storage, user interface, and various execution programs, but are not limited thereto.

According to one embodiment, the user of the content provider terminal (40) may be a content creator (or content producer) who is an individual or company that produces video content.

The content creator, while holding the original rights to the developed content, may share the revenue generated from the video content (hereinafter referred to as ‘content revenue’) with security holders (or investors) who are entitled to share the content revenue. As previously described, the content revenue subject to securitization may refer to revenue from specific content, and in another embodiment, the content revenue subject to securitization may refer to all revenue from content already created and to be created in the future by a specific content creator, or all revenue from all content of a specific type already created and to be created in the future by a specific content creator.

The content revenue may include advertising revenue from content sharing, subscription fee revenue paid by users for the content creator, or additional fee revenue paid by users for the content (e.g., Super Chat, etc.). Meanwhile, if the content is an electronic document such as an e-book, the content revenue may be revenue from e-book sales, but is not limited thereto. In addition, if the content is music, the content revenue may be streaming usage fees for the music, but is not limited thereto. A detailed explanation of content revenue distribution through the content securitization system (100) will be provided later.

The content sharing platform (10) allows content uploaded by a content creator through the content provider terminal (40) (e.g., video) to be posted online so that multiple content users can view it via the content user terminal (20). The advertisement management terminal (50) is a terminal used by advertisers who insert advertisements into video content posted on the content sharing platform (10), and can provide the calculated advertisement cost to the content securitization system (100) in response to advertisement viewing time and click count by the content user terminal (20). Meanwhile, on the content sharing platform (10), users can rate content provided by other users (e.g., out of 5 points), and a matching service may be provided where users who have given each other a score equal to or greater than a predetermined threshold (e.g., 4 points) are matched.

The securities trading terminal (30) may be a terminal used by an investor who purchases content securities that certify the right to share in the expected content revenue from content posted on the content sharing platform (10), or all content of a specific type created by a specific content creator, or all content created by a specific content creator. A user of the securities trading terminal (30) may receive a distribution of content revenue for a given period after a certain investment period has passed, and may also dispose of their owned content securities through a trading platform at their discretion.

The present invention targets as an investment object ‘content securities’ that certify the right to receive distribution of revenue expected from content, or revenue generated from all content of a specific type created by a specific content creator, or revenue generated from all content created by a specific content creator. In other words, it does not target ownership of the content or revenue generated through reproduction as an investment object, but rather targets content revenue derived from the sharing of content, ownership, or copyrights as possible investment objects.

Additionally, the content securitization system (100) (or the content sharing platform (10)) may be a server operator that connects multiple content provider terminals (40) and multiple securities trading terminals (30) online to facilitate investment in content production and to distribute investment funds and content revenue to the content creator (or content producer), server operator, and content security investors according to their respective shares.

The content creator may upload the created content (e.g., videos) to the content sharing platform (10) via the content provider terminal (40). The content securitization system (100) may receive investment for revenue expected from specific content, or from all content of a specific type created by a specific content creator, or from all content created by a specific content creator, and after a certain investment period has passed, may distribute content revenue to the content creator, the content security investors, or the server operator of the content securitization system (100).

Accordingly, the present invention enables the content creator to recover production costs early, enables the server operator to stably receive server operating expenses, and enables the content security investors to obtain investment returns. Furthermore, the present invention can encourage content security investors to actively participate in activities that spread video content, thereby increasing content revenue and potentially making the content creator or performer more famous.

As such, the security investor of the present invention is not merely a financial investor, but may serve as a promoter or marketer of the content creator by sharing the video content posted on the content sharing platform (10) with others through links on their blog, cafe, mini-homepage, bulletin board, etc., thereby increasing content revenue.

Meanwhile, the content securitization system (100) of the present invention may be defined and referred to as a content revenue distribution system. Moreover, the sources of income for the content securitization system (100) of the present invention may include various revenue streams, such as advertising fees obtained from the content sharing platform (10), premium service subscription fees (e.g., YouTube Premium, etc.), product sales fees (e.g., product sales through the sharing platform (10)), paid viewing service fees (e.g., revenue from paid content), special service sales fees (e.g., additional service usage fees to increase exposure frequency to content users (e.g., boosting item sales)), or content security trading fees, and may include at least one of these, but is not limited thereto.

The content securitization system (100) of the present invention may issue securities (hereinafter referred to as ‘content securities’) for specific content or all content of a specific type created by a specific content creator (or content creator), and may distribute the content revenue generated from such content or from all content created by the content creator, or from all content of a specific type created by the specific content creator, based on the content securities. For example, the content revenue generated from content may be distributed to the content creator and to the holders of the content securities. A detailed explanation thereof will be provided later.

As will be described below, the content securities may, at the discretion of the content creator, target: i) specific content selected by the content creator, ii) the content creator as a whole, thereby covering all content created by the content creator, or may target only all content of a specific type created by the specific content creator (for example, only the video content among various types of content created by the specific content creator may be securitized). In case of ii), series content created by the content creator may also be subject to securitization, but depending on the content creator's choice, the series may be excluded from the scope of the securities.

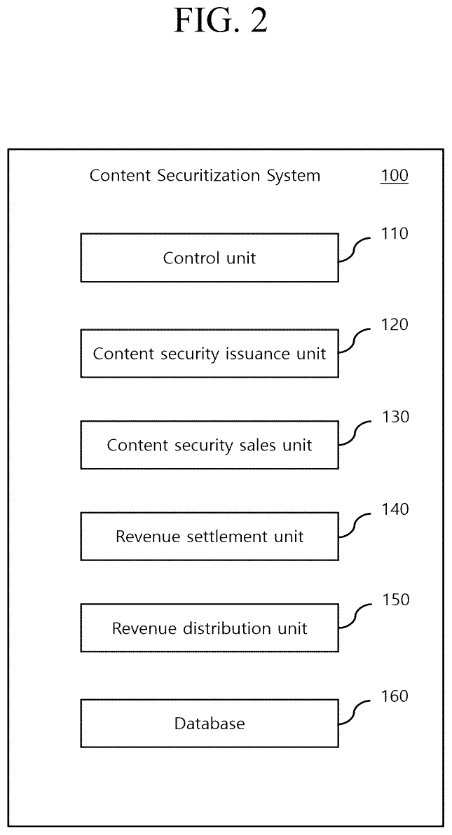

FIG. 2 is a block diagram of a content securitization system according to various embodiments of the present invention.

Referring to FIG. 2, the content securitization system (100) may include a control unit (110), a content security issuance unit (120), a content security sales unit (130), a revenue settlement unit (140), a revenue distribution unit (150), and a database (160).

The control unit (110) may be communicatively connected to the securities trading terminal (30) through a communication module (not shown). Additionally, the control unit (110) may be configured to control the content security issuance unit (120), the content security sales unit (130), the revenue settlement unit (140), the revenue distribution unit (150), and the database (160).

According to one embodiment, the control unit (110) may include a processor and a memory. For example, the processor may include the content security issuance unit (120), the content security sales unit (130), the revenue settlement unit (140), or the revenue distribution unit (150), but is not limited thereto. Also, the memory may include the database (160), but is not limited thereto.

According to some embodiments, the content security issuance unit (120), the content security sales unit (130), the revenue settlement unit (140), or the revenue distribution unit (150) may be implemented as separate, independent processor modules.

The content security issuance unit (120) may issue content securities (e.g., electronic securities) for specific content requested by a content creator (or for all content created by the content creator, or for all content of a specific type created by the content creator). The content security may be a security stating the right to receive a distribution of content revenue. For example, the content security may state the right to receive revenue generated from specific content of a specific content creator, or the right to receive revenue generated from all content of the specific content creator, or from all content of a specific type designated by the content creator. A detailed description thereof will be provided later. Meanwhile, the content security may be provided in the form of a non-fungible token (NFT).

The content security issuance unit (120) may issue the requested number of content securities as requested by the content creator. For example, if the content creator requests the issuance of 1,000 content securities at a price of 1,000 KRW each, the content security issuance unit (120) may issue 1,000 content securities.

The content security issuance unit (120) may issue securities per individual content, and in this process, may divide and issue securities based on specific time units. For example, in the case of a content with a total duration of 10 minutes, 10 different types of securities may be issued, each corresponding to a one-minute segment. In such a case, the different types of securities may be priced higher depending on the number of views and viewing time within their respective time segments. For instance, a security corresponding to a time segment with a high number of views may be issued at a higher price compared to a security for a segment with fewer views.

The content security sales unit (130) may sell the issued content securities to content security investors. For example, if 1,000 content securities are issued at a unit price of 1,000 KRW as mentioned above, the content security sales unit (130) may sell the securities to content security investors who wish to purchase them, in the quantity desired by each investor, at the price of 1,000 KRW per unit. The maximum number of sales may be the number set by the content creator.

A content security investor may access the content security sales unit (130) of the content securitization system (100) through the securities trading terminal (30) and purchase the content securities. For example, the content security investor may purchase the desired quantity of content securities at 1,000 KRW each. Information about the content security investor who has purchased the content securities (e.g., personal information for tax processing or account information for profit distribution) may be stored in the database (160).

The revenue settlement unit (140) may settle revenue generated from the content. For example, it may settle the revenue generated during a predetermined period from specific content of a specific content creator, or from all content of a specific type designated by the content creator, or from all content of the specific content creator. In this case, the revenue settlement unit (140) may calculate the remaining content revenue—after deducting a predetermined fee for the server operator of the content securitization system (100)—for distribution to the content creator and content security holders, but is not limited thereto.

The revenue distribution unit (150) may distribute the settled content revenue to the content creator or the content security holders based on the revenue distribution criteria. A detailed description of this will be provided later.

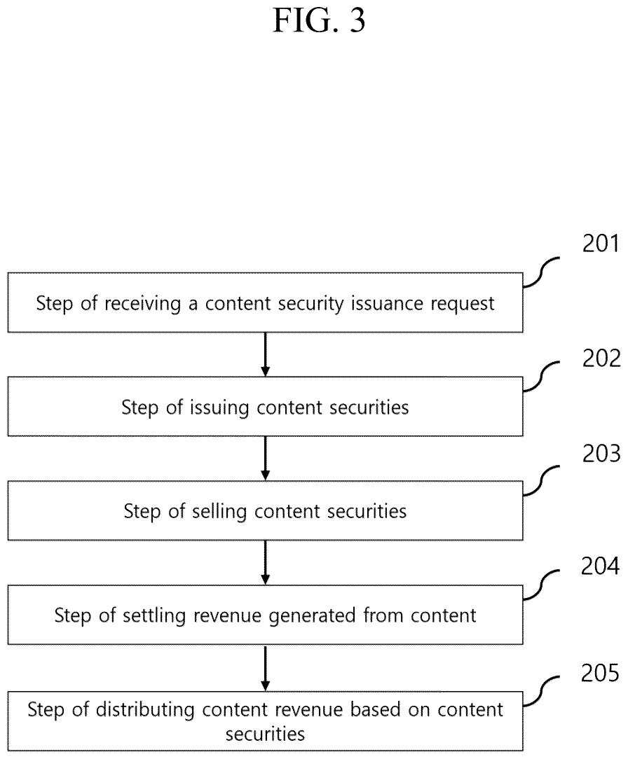

FIG. 3 is a flowchart for explaining the method of operating the content securitization system according to various embodiments of the present invention.

Referring to FIG. 3, the operation method of the content securitization system (100) may include: receiving a content security issuance request (201), issuing content securities (202), selling content securities (203), settling revenue generated from content (204), and distributing content revenue based on the content securities (205).

The step of receiving a content security issuance request (201) may be a step in which the control unit (110) receives a request from a content creator to issue content securities for the content creator's specific content, all content of a specific type designated by the content creator, or all content created by the specific content creator. For example, the content creator may input a request into the content securitization system (100), via the content provider terminal (40), to issue content securities for their specific content, for all content of a specific type, or for all content.

The request to issue the content securities may include: information indicating whether the securities are to be issued for specific content of the content creator, for all content of a specific type, or for all content of the content creator (in this case, the securities may be targeted at all content of the content creator); information about the number of content securities to be issued; information about the percentage of the total shares held by the content creator; information about the percentage of shares that can be purchased; information about the percentage of revenue per share that the content creator has designated for dividend; and information about the sale price of the content securities. Additionally, the request to issue content securities may include information about the allocation ratio, indicating the percentage of content revenue the content creator will definitively retain.

The step of issuing content securities (202) may be a step in which the content security issuance unit (120) issues the content securities. For example, the content securities issued by the content security issuance unit (120) may include information such as the content creator's information, information about the relevant content, information about the content creator's revenue allocation ratio, price information of the content securities, and the total number of issued content securities, but is not limited thereto.

The step of settling revenue generated from content (204) may be a step in which the revenue settlement unit (140) settles the remaining amount—excluding the server operating costs of the server operator of the content securitization system (100)—from the revenue generated from the content, as the content revenue. The settled content revenue may be distributed to the content creator or the content security investors.

The step of distributing content revenue based on the content securities (205) may be a step in which the revenue distribution unit (150) distributes the content revenue, settled by the revenue settlement unit (140), to the content creator or the content security investors according to the revenue distribution criteria. For example, the revenue distribution unit (150) may distribute the content revenue according to the revenue distribution criteria and deposit the corresponding amount into the account of the content creator or the content security investor. Meanwhile, the revenue distribution criteria (or the table storing the revenue distribution information) may be stored in the database (160), but is not limited thereto.

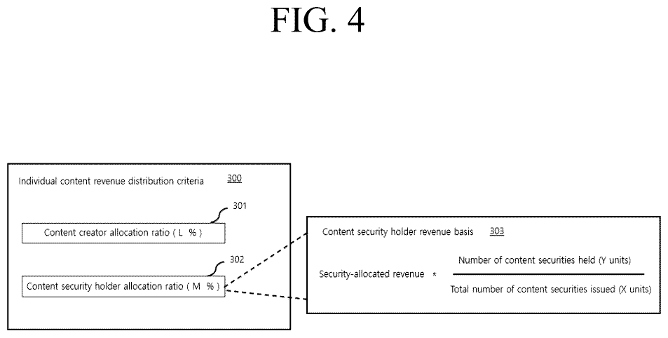

FIG. 4 is a schematic diagram for explaining the individual content revenue distribution criteria according to various embodiments of the present invention.

For example, the content revenue distribution criteria (300) described with reference to FIG. 4 is a diagram for explaining the criteria for distributing content revenue generated from specific content, in a case where a specific content creator has issued content securities based on revenue expected from specific content.

Referring to FIG. 4, the individual content revenue distribution criteria (300) may be the criteria for distributing the content revenue generated from specific content.

For example, from the total revenue generated from specific content, the content revenue settled by the revenue settlement unit (140) may be distributed to the content creator and the content security holders via the revenue distribution unit (150). For instance, the amount allocated to the content creator may be an amount corresponding to an allocation ratio (L %) set by the content creator out of the content revenue. The allocation ratio (L %) may be the ratio set by the content creator at the time of issuing the content securities. The amount calculated from content revenue×allocation ratio (L %) may be the amount attributable to the content creator (301).

Additionally, the amount allocated to the content security holders may be an amount corresponding to an allocation ratio (M %) set by the content creator out of the content revenue. The allocation ratio (M %) may also be the ratio set by the content creator at the time of issuing the content securities. In one example, M may be the value of 100−L, but is not limited thereto. The amount calculated from content revenue×allocation ratio (M %) may be the amount attributable to the content security holders (302).

The amount calculated from content revenue×allocation ratio (M %) may also be referred to as security-allocated revenue. The security-allocated revenue may be distributed to each content security holder in accordance with their holding ratio of the content securities (303).

For example, each content security investor holding content securities may receive an amount calculated from: security-allocated revenue×((number of content securities held (Y units)/total number of content securities issued (X units))).

Meanwhile, the total number of content securities issued (X units) may be the number of content securities requested for issuance by the content creator, or may be the number of content securities that were actually sold among the requested securities.

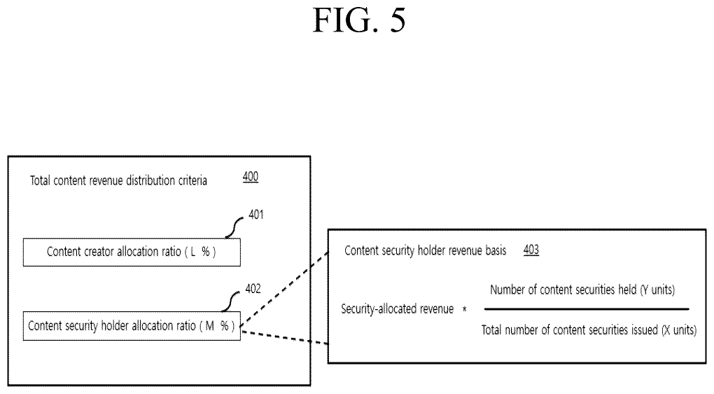

If content securities are issued based on revenue distribution criteria like that shown in FIG. 4, the content creator can securitize the expected revenue from each piece of content, thereby providing the advantage of enabling the content creator to more easily secure content production costs. FIG. 5 is a schematic diagram for explaining the total content revenue distribution criteria according to various embodiments of the present invention.

For example, the content revenue distribution criteria (400) described with reference to FIG. 5 is a diagram for explaining the criteria for distributing content revenue generated from all content created by a specific content creator, in a case where content securities (issued on a per-content creator basis) have been issued for the revenue from all such content.

Referring to FIG. 5, the total content revenue distribution criteria (400) may be the criteria for distributing content revenue generated from all content created by a content creator.

For example, from the total revenue generated from all content, the content revenue settled by the revenue settlement unit (140) may be distributed to the content creator and the content security holders via the revenue distribution unit (150). For instance, the amount allocated to the content creator may be an amount corresponding to an allocation ratio (L %) set by the content creator out of the content revenue. The allocation ratio (L %) may be the ratio set by the content creator at the time of issuing the content securities. The amount calculated from content revenue×allocation ratio (L %) may be the amount attributable to the content creator (401).

Additionally, the amount allocated to the content security holders may be an amount corresponding to an allocation ratio (M %) set by the content creator out of the content revenue. The allocation ratio (M %) may also be the ratio set by the content creator at the time of issuing the content securities. In one example, M may be the value of 100−L, but is not limited thereto. The amount calculated from content revenue×allocation ratio (M %) may be the amount attributable to the content security holders (402).

The amount calculated from content revenue×allocation ratio (M %) may also be referred to as security-allocated revenue. The security-allocated revenue may be distributed to each content security holder in accordance with their holding ratio of the content securities (403).

For example, each content security investor holding content securities may receive an amount calculated from: security-allocated revenue×((number of content securities held (Y units)/total number of content securities issued (X units))).

Meanwhile, the total number of content securities issued (X units) may be the number of content securities requested for issuance by the content creator, or may be the number of content securities that were actually sold among the requested securities.

If content securities are issued based on revenue distribution criteria like that shown in FIG. 5, the content security investor can receive a distribution of revenue generated from all content created by the specific content creator in which they invested. For example, since content revenue can be distributed from both content provided at the time the content securities were issued and from content created and provided after the issuance of the content securities, it is possible to generate continuous revenue from a single content security.

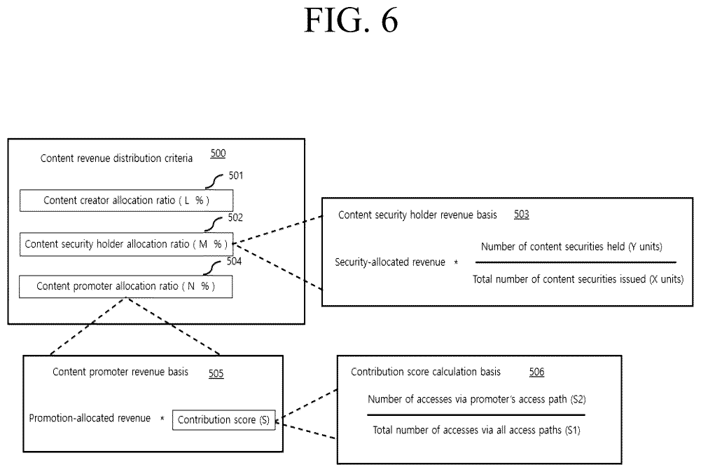

FIG. 6 is a schematic diagram for explaining the content revenue distribution criteria according to various embodiments of the present invention.

For example, the content revenue distribution criteria (500) described with reference to FIG. 6 is a diagram for explaining the criteria for distributing content revenue, which is applicable in all cases where content securities have been issued based on revenue generated from specific content by a specific content creator (e.g., FIG. 4), from all content created by a specific content creator (e.g., FIG. 5), or from all content of a specific type created by a specific content creator.

Referring to FIG. 6, the content revenue distribution criteria (500) may be the criteria for distributing content revenue generated from specific content, all content of a specific type, or all content of a content creator.

For example, from the revenue generated by content, the content revenue settled by the revenue settlement unit (140) may be distributed to the content creator, content security holders, and content promoters via the revenue distribution unit (150). For instance, the amount allocated to the content creator may be an amount corresponding to the allocation ratio (L %) set by the content creator out of the content revenue. The allocation ratio (L %) may be the ratio set by the content creator at the time of issuing the content securities. The amount calculated from content revenue×allocation ratio (L %) may be the amount attributable to the content creator (501).

Additionally, the amount allocated to the content security holders may be an amount corresponding to the allocation ratio (M %) set by the content creator out of the content revenue. The allocation ratio (M %) may be the ratio set by the content creator at the time of issuing the content securities. In one example, M may be the value of 100−L−N, but is not limited thereto. The amount calculated from content revenue×allocation ratio (M %) may be the amount attributable to the content security holders (502).

The amount calculated from content revenue×allocation ratio (M %) may also be referred to as security-allocated revenue. The security-allocated revenue may be distributed to each content security holder in accordance with their holding ratio of the content securities (503).

For example, each content security investor holding content securities may receive an amount calculated from: security-allocated revenue×((number of content securities held (Y units)/total number of content securities issued (X units))).

Meanwhile, the total number of content securities issued (X units) may be the number of content securities requested for issuance by the content creator, or may be the number of content securities that were actually sold among the requested securities.

Additionally, the amount allocated to content promoters may be an amount corresponding to the allocation ratio (N %) set by the content creator out of the content revenue. The allocation ratio (N %) may also be the ratio set by the content creator at the time of issuing the content securities. In one example, N may be the value of 100−L−M, but is not limited thereto. The amount calculated from content revenue×allocation ratio (N %) may be the amount attributable to the content promoters (504).

Content promoters may be individuals who, as content security holders, promote content through various channels. For example, content promoters may receive access paths such as a URL link or a QR code link from the content securitization system (100), and may promote the corresponding content by uploading the access path to their blog, mini-homepage, SNS, or various websites. The access path may consist of a unique URL link or QR code link for each content security holder, and the number of accesses to the content through each access path may be counted as users referred by the content security holder who received that access path.

The amount calculated from content revenue×allocation ratio (N %) may also be referred to as promotion-allocated revenue. The promotion-allocated revenue may be distributed to each content promoter according to their contribution score(S) (505).

Each content promoter may receive an amount calculated from: promotion-allocated revenue×((number of accesses through the promoter's access path (S2))/(total number of accesses through all access paths (S1))). According to another embodiment, each content promoter may receive an amount calculated from one of the following: promotion-allocated revenue×(number of accesses through the promoter's access path (S2)), promotion-allocated revenue×(number of specific content securities purchased through the promoter's access path), promotion-allocated revenue×(number of platform sign-ups through the promoter's access path), or promotion-allocated revenue×((number of platform sign-ups through the promoter's access path)/(total number of sign-ups through all access paths)) (506). For example, content promoters may receive promotion-allocated revenue proportionally based on the ratio of accesses through their access path (S2) to the total number of accesses through all issued access paths (S1).

Meanwhile, if content securities are issued with a revenue distribution structure like that shown in FIG. 6, content security investors may receive a portion of the content revenue generated from the content, based on their securities holdings. In addition, those content security investors who engage in promoting the content may receive additional promotion-allocated revenue according to their promotional contribution. As a result, content promotion can be effectively encouraged among content security investors. Furthermore, the promotion-allocated revenue may be calculated based on the content revenue generated within a period set by the content creator from the time of the initial content issuance (e.g., one month), and for content revenue generated after that period, no separate promotion-allocated revenue may be distributed; instead, the content revenue may be distributed only to the content creator and the content security holders.

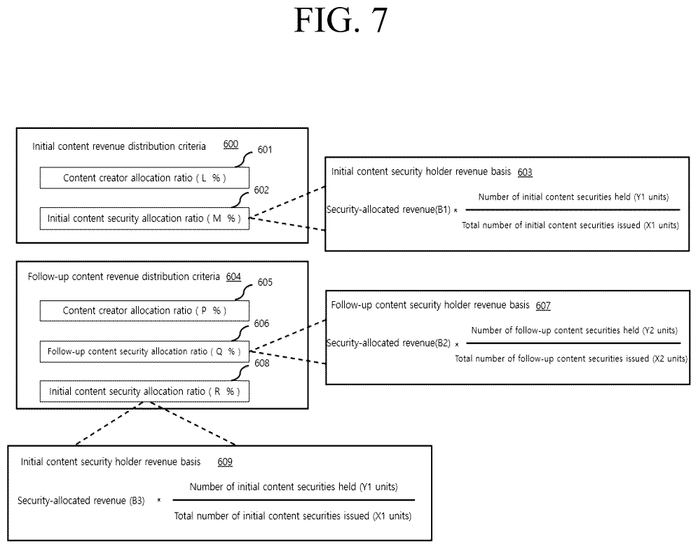

FIG. 7 is a schematic diagram for explaining the series content revenue distribution criteria according to various embodiments of the present invention.

For example, the content revenue distribution criteria (600) described with reference to FIG. 7 is a diagram for explaining the criteria for distributing content revenue generated from a series of content, in the case where a specific content creator plans a series and issues content securities based on it.

Referring to FIG. 7, the initial content revenue distribution criteria (600) may be the criteria for distributing the content revenue generated from the initial content of the content creator's series content.

For example, series content may be content repeatedly produced by the content creator under the same or similar category. For instance, it may be content operated in a seasonal format.

The initial content may refer to the first piece of content created in the series. The subsequent content may refer to content created after the initial content within the series.

Initial content securities may be content securities issued at the time of creating the initial content, which state the right to receive revenue generated from both the initial content and the subsequent content in the series. Subsequent content securities may be content securities issued at the time of creating the subsequent content, which state the right to receive revenue generated from the subsequent content in the series.

Initial content revenue may refer to the revenue generated from the initial content, settled by the revenue settlement unit (140). Subsequent content revenue may refer to the revenue generated from the subsequent content, settled by the revenue settlement unit (140).

For example, from the revenue generated from the initial content, the initial content revenue settled by the revenue settlement unit (140) may be distributed to the content creator and the initial content security holders via the revenue distribution unit (150). For instance, the amount allocated to the content creator may be an amount corresponding to the allocation ratio (L %) set by the content creator out of the initial content revenue. The allocation ratio (L %) may be the ratio set by the content creator at the time of issuing the initial content securities. The amount calculated from initial content revenue×allocation ratio (L %) may be the amount attributable to the content creator (601).

Additionally, the amount allocated to the initial content security holders from the initial content revenue may be an amount corresponding to the allocation ratio (M %) set by the content creator out of the initial content revenue. The allocation ratio (M %) may be the ratio set by the content creator at the time of issuing the initial content securities. In one example, M may be the value of 100−L, but is not limited thereto. The amount calculated from initial content revenue×allocation ratio (M %) may be the amount attributable to the initial content security holders (602).

The amount calculated from initial content revenue×allocation ratio (M %) may also be referred to as security-allocated revenue (B1). The security-allocated revenue (B1) may be distributed to each initial content security holder in proportion to their holding ratio of the initial content securities (603).

For example, each content security investor holding initial content securities may receive an amount calculated from: security-allocated revenue (B1)×((number of initial content securities held (Y1 units)/total number of initial content securities issued (X1 units)))

Meanwhile, the total number of initial content securities issued (X1 units) may be the number of initial content securities requested for issuance by the content creator, or the number of initial content securities actually sold among those requested.

Subsequently, from the revenue generated by the follow-up content, the follow-up content revenue settled by the revenue settlement unit (140) may be distributed to the content creator and the follow-up content security holders via the revenue distribution unit (150) (604). For example, the amount allocated to the content creator may be an amount corresponding to the allocation ratio (P %) set by the content creator out of the follow-up content revenue. The allocation ratio (P %) may be the ratio set by the content creator at the time of issuing the follow-up content securities. The amount calculated from follow-up content revenue×allocation ratio (P %) may be the amount attributable to the content creator (605).

Additionally, the amount allocated to follow-up content security holders from the follow-up content revenue may be an amount corresponding to the allocation ratio (Q %) set by the content creator. The allocation ratio (Q %) may also be set at the time of issuing the follow-up content securities. In one example, Q may be the value of 100−P−R, but is not limited thereto. The amount calculated from follow-up content revenue×allocation ratio (Q %) may be the amount attributable to the follow-up content security holders (606).

The amount calculated from follow-up content revenue×allocation ratio (Q %) may also be referred to as security-allocated revenue (B2). The security-allocated revenue (B2) may be distributed to each follow-up content security holder in proportion to their holding ratio of the follow-up content securities (607).

For example, each content security investor holding follow-up content securities may receive an amount calculated from: security-allocated revenue (B2)×((number of follow-up content securities held (Y2 units)/total number of follow-up content securities issued (X2 units))).

Meanwhile, the total number of follow-up content securities issued (X2 units) may be the number of follow-up content securities requested for issuance by the content creator, or the number of follow-up content securities actually sold among those requested.

Additionally, the amount allocated to initial content security holders from the follow-up content revenue may be an amount corresponding to the allocation ratio (R %) set by the content creator. The allocation ratio (R %) may be the ratio set by the content creator at the time of issuing the follow-up content securities. In one example, R may be the value of 100−P−Q, but is not limited thereto. The amount calculated from follow-up content revenue×allocation ratio (R %) may be the amount attributable to the initial content security holders (608).

The amount calculated from follow-up content revenue×allocation ratio (R %) may also be referred to as security-allocated revenue (B3). The security-allocated revenue (B3) may be distributed to each initial content security holder in proportion to their holding ratio of the initial content securities (609).

For example, each content security investor holding initial content securities may receive an amount calculated from: security-allocated revenue (B3)×((number of initial content securities held (Y1 units)/total number of initial content securities issued (X1 units))).

If content securities are issued based on revenue distribution criteria such as those illustrated in FIG. 7, the production of series content can be actively promoted. The content creator can secure production costs both at the time of creating the initial content and the follow-up content through the issuance of initial and follow-up content securities. Furthermore, by distributing revenue from follow-up content to initial content security investors, the system can incentivize the purchase of initial content securities at the time of issuance.

The devices, systems, or components thereof described above may be implemented using hardware components, software components, and/or a combination of hardware and software components. For example, the devices, systems, and components described in the embodiments may be implemented using one or more general-purpose or special-purpose computers, such as a processor, controller, ALU (arithmetic logic unit), digital signal processor, microcomputer, FPGA (field programmable gate array), PLU (programmable logic unit), microprocessor, or any other device capable of executing and responding to instructions. The processing device may execute an operating system (OS) and one or more software applications running on the OS. In addition, the processing device may, in response to the execution of software, access, store, manipulate, process, and generate data. For ease of understanding, the processing device may be described as singular, but one of ordinary skill in the art will appreciate that the processing device may include multiple processing elements and/or multiple types of processing elements. For example, the processing device may include multiple processors or a processor and a controller. Other processing configurations such as parallel processors may also be used.

Software may include a computer program, code, instructions, or a combination of one or more of these, and may configure a processing device to operate as desired or independently or collectively direct the processing device. The software and/or data may be embodied permanently or temporarily in any type of machine, component, physical device, virtual equipment, computer-readable storage medium or device, or signal wave for interpretation or command/data delivery to a processing device. The software may be distributed across a networked computer system and stored or executed in a distributed manner. Software and data may be stored in one or more computer-readable recording media.

The method according to the embodiment may be implemented in the form of program instructions that can be executed via various computer means and may be recorded in a computer-readable medium. The computer-readable medium may include program instructions, data files, data structures, or a combination thereof. The program instructions recorded on the medium may be specially designed and configured for the embodiments, or may be known and available to those skilled in computer software. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of program instructions include machine code generated by a compiler, as well as high-level language code executable by a computer using an interpreter or the like. The above-described hardware devices may be configured to operate as one or more software modules to perform the operations of the embodiments, and vice versa.

As described above, although the embodiments have been described with reference to limited embodiments and figures, various modifications and variations may be made based on the above disclosures by those skilled in the art. For example, the described technologies may be performed in a different order than described, and/or the described system, structure, device, or circuit components may be combined or integrated in a different manner, or substituted with different components or equivalents while still achieving appropriate results.

Therefore, other implementations, other embodiments, and equivalents to the following claims also fall within the scope of the claims that follow.

### DESCRIPTION OF REFERENCE NUMERALS

100: Content Securitization System
110: Control Unit
120: Content Security Issuance Unit
130: Content Security Sales Unit
140: Revenue Settlement Unit
150: Revenue Distribution Unit
160: Database

What is claimed is:

1. A content securitization system, comprising:
a content security issuance unit configured to issue content securities stating a right to share in revenue generated from a content creator's content;
a content security sales unit configured to sell the content securities issued by the content security issuance unit;
a revenue settlement unit configured to settle revenue generated from the content as content revenue; and
a revenue distribution unit configured to distribute the settled content revenue to the content creator or content security investors,
wherein the revenue distribution unit is configured to:
(i) distribute, to the content creator, an amount corresponding to a proportion allocated to the content creator from the settled content revenue; and
(ii) distribute, to each content security holder, a remaining amount of the settled content revenue, excluding the amount distributed to the content creator, in accordance with their holding ratio of the content securities.

2. The content securitization system according to claim 1,
wherein the revenue generated from the content is revenue generated from specific content designated by the content creator.

3. The content securitization system according to claim 1,
wherein the revenue generated from the content is revenue generated from all content created by the content creator, or revenue generated from specific types of content selected by the content creator.

4. The content securitization system according to claim 1,
wherein the revenue distribution unit is configured to distribute the settled content revenue to the content creator, content security investors, or content promoters.

5. The content securitization system according to claim 4,
wherein the revenue distribution unit is configured to:
(i) distribute, to the content creator, an amount corresponding to the proportion allocated to the content creator from the settled content revenue;
(ii) distribute, to each content security holder, an amount corresponding to the proportion allocated to the content security investors from the settled content revenue, in accordance with their holding ratio of the content securities; and
(iii) distribute, to each content promoter, an amount corresponding to the proportion allocated to the content promoters from the settled content revenue, based on a contribution score.

6. The content securitization system according to claim 1,
wherein the revenue distribution unit is configured to distribute, to each content security holder, an amount corresponding to the proportion allocated to content security investors from revenue generated from follow-up content of the content, which is settled by the revenue settlement unit, in accordance with their holding ratio of the content securities.

7. The content securitization system according to claim 1,
wherein the content security is provided as a non-fungible token (NFT).

8. A method for operating a content securitization system, comprising:
receiving a request to issue content securities;
issuing the content securities;
selling the content securities;
settling revenue generated from the content; and
distributing the settled content revenue to a content creator and content security investors based on the content securities,
wherein in the distributing step,
an amount corresponding to a proportion allocated to content security investors from a follow-up content revenue, which is settled based on revenue generated from follow-up content of the content, is distributed to each content security holder in accordance with their holding ratio of the content securities.
